(19) United States
(12) Patent Application Publication
(10) Pub. No.: US 2011/0320021 A1
(43) Pub. Date: Dec. 29, 2011

(54) PLAYLIST GENERATING APPARATUS, PLAYLIST GENERATING METHOD, PLAYLIST GENERATING PROGRAM, AND RECORDING MEDIUM

(75) Inventors: Kazushi Tahara, Saitama (JP); Fumiaki Kikuchi, Saitama (JP)

(73) Assignee: PIONEER CORPORATION, Kawasaki-shi, Kanagawa (JP)

(21) Appl. No.: 13/142,157

(22) PCT Filed: Dec. 25, 2008
(86) PCT No.: PCT/JP2008/073630

§ 371 Date: Jun. 24, 2011

(51) Int. Cl. G06F 17/00

(52) U.S. Cl. 700/94

(57) ABSTRACT

A playlist generating apparatus that generates a playlist of content items to be played on a content playing apparatus and includes an acquiring unit that acquires information related to a content item portion listened to/viewed by a user, where the content item includes multiple given portions; a determining unit that using the acquired information, determines what proportion of the given portions has been listened to/viewed by the user; and a generating unit that generates the playlist, based on a determination result obtained by the determining unit.

### TECHNICAL FIELD

The present invention relates to a playlist generating apparatus, a playlist generating method, a playlist generating program, and recording medium that generate a playlist of content to be played on a content playing apparatus. However, utilization of the present invention is not limited to the playlist generating apparatus, the playlist generating method, the playlist generating program, and the recording medium above.

### BACKGROUND ART

Technology that automatically generates a playlist displaying the sequence in which content (primarily music) is to be played by a content playing apparatus has been known. To automatically generate a playlist, for example, a method of preliminarily analyzing music and selecting situation-appropriate music as well as a method of determining user preferences based on user operation of a content playing apparatus and selecting music that matches user preferences are known (see, for example, Patent Documents 1 and 2). Patent Document 1 discloses a technology where if a skip operation is performed, a score is calculated for the track as a track that the user does not want to hear and the playlist indicating the sequence that the music is to be played is updated. Further, Patent Document 2 discloses a technology where user preference for a track is calculated based on the amount of time that the track is played.

Technologies that analyze the structure of music and identify the hook, as well as technology that analyzes video content and identifies highlight portions are known (see, for example, Patent Documents 3 and 4 below).
Patent Document 1: Japanese Patent Application Laid-Open Publication No. 2008-216486
Patent Document 2: Japanese Patent Application Laid-Open Publication No. 2007-058481
Patent Document 3: Japanese Patent Application Laid-Open Publication No. 2004-184769
Patent Document 4: Japanese Patent Application Laid-Open Publication No. 2007-251816

### DISCLOSURE OF INVENTION

### Problem to be Solved by the Invention

Nevertheless, with the conventional technologies above, a problem arises in that, for example, sufficiently reflecting user preferences in a playlist is difficult. For instance, even if the user likes a track, the ending repeat of the track may be skipped and the next track previewed. Further, if there are changes in user preference over time, sufficiently reflecting user preference in a playlist is difficult.

### Means for Solving Problem

To solve the problems above and achieve an object, a playlist generating apparatus according to the invention of claim 1 includes an acquiring unit that acquires information related to a portion of content listened to/viewed by a user; a determining unit that using the information that is related to a portion of content listened to/viewed by the user and acquired by the acquiring unit, determines whether a given portion of the content has been listened to/viewed; and a generating unit that based on a determination result obtained by the determining unit, generates a playlist.

Further, a playlist generating method according to the invention of claim 8 includes acquiring information related to a portion of content listened to/viewed by a user; determining, by using the information that is related to a portion of content listened to/viewed by the user and acquired at the acquiring, whether a given portion of the content has been listened to/viewed; and generating a playlist, based on a determination result obtained at the determining.

A playlist generating program according to the invention of claim 9 causes a computer to execute the playlist generating method according to claim 8.

A recording medium according to the invention of claim 10 stores therein in a computer-readable state, the playlist generating program according to claim 9.

### BRIEF DESCRIPTION OF DRAWINGS

FIG. 1 is a block diagram of a functional configuration of a playlist generating apparatus according to the present invention;

FIG. 2 is a flowchart of a procedure of playlist generation processing by the playlist generating apparatus;

FIG. 3 is a block diagram of a hardware configuration of a navigation apparatus;

FIG. 4 is a diagram for describing an evaluation method of a track of music;

FIG. 5 is a flowchart of a procedure of music evaluation processing by the navigation apparatus;

FIG. 6 is a flowchart of a procedure of the playlist generation processing by the navigation apparatus;

FIG. 7 is a graph depicting an example of the relation between the score given to a track and elapsed time since the date of listening; and

FIG. 8 is a graph of another example of the relation of the score given to a track and elapsed time since the date of listening.

### EXPLANATIONS OF LETTERS OR NUMERALS

100 playlist generating apparatus
101 acquiring unit
102 determining unit
103 generating unit

### BEST MODE(S) FOR CARRYING OUT THE INVENTION

With reference to the accompanying drawings, a playlist generating apparatus, a playlist generating method, a playlist generating program, and recording medium according to the present invention will be described.

### Embodiment

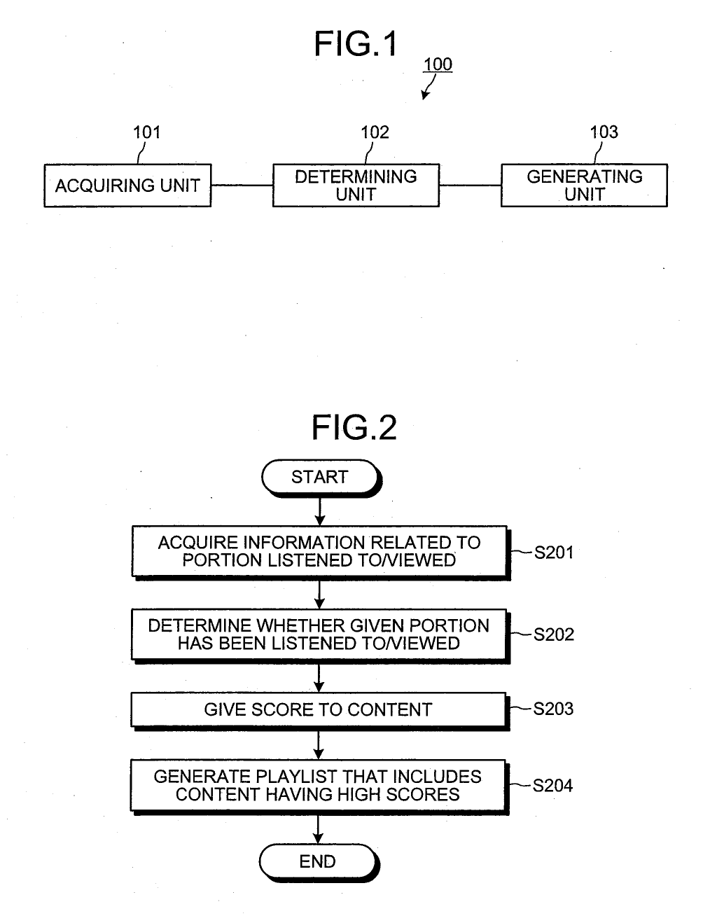

FIG. 1 is a block diagram of a functional configuration of a playlist generating apparatus according to the present invention. A playlist generating apparatus 100 includes an acquiring unit, a determining unit 102, and a generating unit 103 and generates a playlist of content to be played by a non-depicted content playing apparatus.

The acquiring unit 101 acquires information related to a portion of content listened to/viewed by the user. The acquiring unit 101, for example, acquires information indicative of whether the user listened to/viewed content from start to end and the point to which the user listened/viewed if the content was not listened to/viewed to the end. In addition to information related to the portion of content listened to/viewed, the acquiring unit 101 may acquire date and time information of listening/viewing and surrounding environment information for the time when the content was listened to/viewed. Here, surrounding environment information is situation information indicative of the place, the weather, companions, etc. at the time that content was listened to/viewed.

The determining unit 102, using the information related to the listened to/viewed portion acquired by the acquiring unit 101, determines whether a given portion in content has been listened to/viewed. The given portion of content is, for example, the hook in the case of content that is music, and video accompanying the hook in the case of content that is a promotion video for music. Further, if the content is video, the given portion is a highlight in the content, i.e., a portion where the audio level is high, etc. If there are multiple hooks in the content, the determining unit determines whether up to any of the hooks has been listened to/viewed.

The generating unit 103, based on a determination result of the determining unit 102, generates a playlist. The generating unit 103, for example, preferentially includes in the playlist, content having a given portion that has been listened/viewed. Specifically, for example, based on the determination result of the determining unit 102, the generating unit 103 gives the content a score and if generating the playlist based on the score, gives content having a given portion that has been listened to/viewed, a higher score and generates the playlist to include content in descending order of score.

Further, the generating unit 103 may generate the playlist based on date and time information of listening/viewing and surrounding environment information in addition to the determination result of the determining unit 102. Specifically, for example, using date and time information of listening/viewing, the generating unit 103 decreases the score given to content according to the amount of time that has elapsed since listening/viewing; using the surrounding environment information, the generating unit 103 preferentially includes content that has been listened to/viewed in a surrounding environment similar to that when the current playlist under generation is to be played.

FIG. 2 is a flowchart of a procedure of playlist generation processing by the playlist generating apparatus. In the flowchart depicted in FIG. 2, the playlist generating unit 100, using the acquiring unit 101, acquires information related to a portion of content listened to/viewed by the user (step S201). Next, the playlist generating apparatus 100, using the determining unit 102, determines whether a given portion of content has been listened to/viewed (step S202).

The playlist generating apparatus 100 gives the content a score based on the determination result at step S202 (step S203). Specifically, the playlist generating apparatus 100 gives content that has a given portion that has been listened to/viewed, a high score. Subsequently, the playlist generating apparatus 100, using the generating unit 103, generates a playlist that includes content having a high score (step S204), ending the processing according to this flowchart.

As described, according to the playlist generating apparatus 100, content is evaluated based on whether the user has listened to/viewed a given portion of the content, and using the evaluation, a playlist is generated, whereby a playlist reflecting user preference with high accuracy can be generated.

Further, according to the playlist generating apparatus 100, a playlist is generated based on date and time information of content listening/viewing by the user, whereby a playlist can be generated that with high accuracy, reflects user preference, which changes over time.

### Example

Hereinafter, an example of the present invention will be described. In the example, a navigation apparatus 300 disposed on a vehicle will be described as one example of application of the playlist generating apparatus 100.

### (Hardware Configuration of Navigation Apparatus)

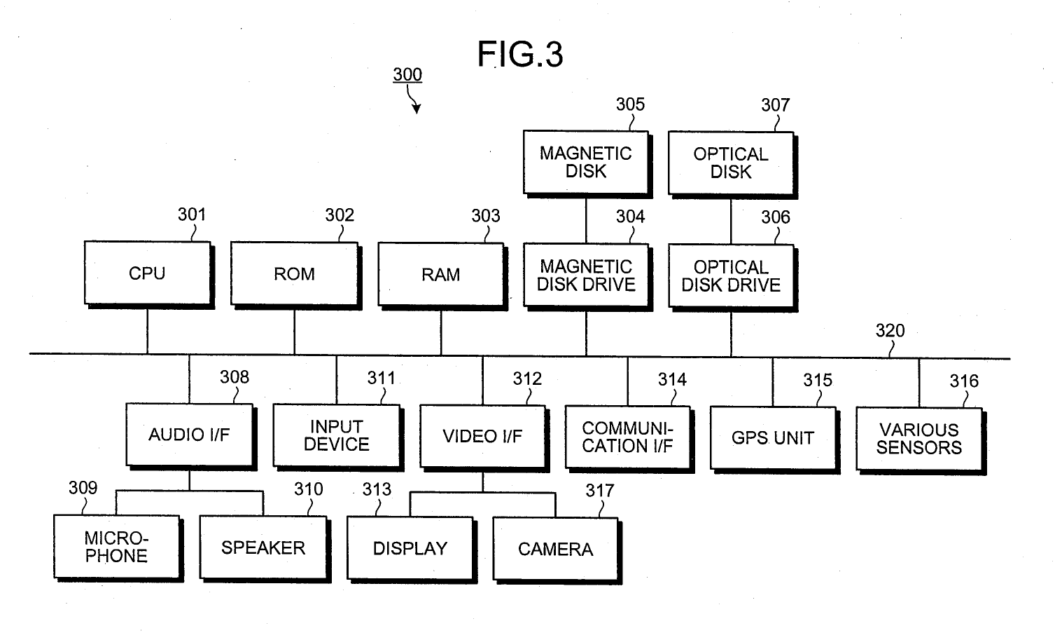

First, a hardware configuration of the navigation apparatus 300 will be described. FIG. 3 is a block diagram of a hardware configuration of the navigation apparatus. As depicted in FIG. 3, the navigation apparatus 300 includes a CPU 301, a ROM 302, a RAM 303, a magnetic disk drive 304, a magnetic disk 305, an optical disk drive 306, an optical disk 307, an audio I/F (interface) 308, a microphone 309, a speaker 310, an input device 311, a video I/F 312, a display 313, a communication I/F 314, a GPS unit 315, various sensors 316, and a camera 317, respectively connected by a bus 320.

The CPU 301 governs overall control of the navigation apparatus 300. The ROM 302 stores therein various types of programs such as a boot program and a data updating program. The RAM 303 is used as a work area of the CPU 301. In other words, the CPU 301 uses the RAM 303 as a work area while executing various programs stored on the ROM 302 to govern overall control of the navigation apparatus 300.

The magnetic disk drive 304, under the control of the CPU 301, controls the reading and the writing of data with respect to the magnetic disk 305. The magnetic disk 305 stores data written thereto under the control of the magnetic disk drive 304. A HD (hard disk), an FD (flexible disk), etc. may, for example, be used as the magnetic disk 305.

The optical disk drive 306, under the control of the CPU 301, controls the reading and the writing of data with respect to the optical disk 307. The optical disk 307 is a removable recording medium from which data can be readout under the control of the optical disk drive 306. A writable recording medium may also be used for the optical disk 307. In addition to the optical disk 307, an MO, memory card, etc. can be used alternatively as a removable recording medium.

An example of information recorded to the magnetic disk 305 and the optical disk 307 is content data and map data. Content data is, for example, music data, still image data, moving picture data, etc. Map data includes background data indicating terrestrial objects (features) such as buildings, rivers, ground surfaces, etc. and road-shape data indicating the shapes of road; the map data is constituted by data files separated according to region.

The audio I/F 308 is connected to the microphone 309 for audio input and the speaker 310 for audio output. Sound received by the microphone 309 is A/D converted in the audio I/F 308. The microphone 309, for example, may be disposed on a sun visor of the vehicle. From the speaker 310, sound is output that has been D/A converted in the audio I/F 308 from an audio signal.

The input device 311 may be a remote controller, a keyboard, a touch panel, etc. having keys for inputting characters, numerals, various instructions, etc. The input device 311 may be implemented by any one or combination of the remote controller, the keyboard, and the touch panel.

The video I/F 312 is connected to the display 313. The video I/F 312, specifically, for example, is made up a graphic controller that governs overall control of the display 313, a buffer memory such as VRAM (Video RAM) that temporarily records immediately displayable image information, and a control IC that based on image data output from a graphic controller, controls the display 313.

The display 313 displays icons, cursors, menus, windows, or various data such as characters and images. The display 313 displays the map data two dimensionally or three dimensionally. The map data displayed on the display 313 can be displayed superimposed with a mark indicating the current position of the vehicle on which the navigation apparatus 300 is disposed. The current position of the vehicle is computed by the CPU 301. A TFT liquid crystal display, an organic electroluminescence display, etc., may be used as the display 313.

The communication I/F 314 is wirelessly connected to a network and functions as an interface between the navigation apparatus 300 and the CPU 301. Further, the communication I/F 314 is wirelessly connected to a communication network such as the Internet and also functions as an interface between the CPU 301 and the communication network.

The GPS unit 315 receives signals from GPS satellites and outputs information indicating the current position of the vehicle. The information output from the GPS unit 315 is used along with values output from the various sensors 316 described hereinafter when the CPU 301 calculates the current position of the vehicle. The information indicating the current position is information specifying a point with respect to the map information, for example, latitude/longitude and altitude.

The various sensors 316 include a speed sensor, an acceleration sensor and an angular-velocity sensor, and output information that enables determination of position and behavior of the vehicle. The values output from the various sensors 316 are used by the CPU 301 for calculating the current position of the vehicle and measuring changes in speed and direction.

The camera 317 shoots an image inside or outside the vehicle 430. The image may be a still image or a moving image. The camera 317 captures the behavior of persons in the vehicle as an image and outputs the image via the video I/F 312 to a recording medium such as the magnetic disk 305 and the optical disk 307.

Functions of the acquiring unit 101, the determining unit 102, and the generating unit 103 of the playlist generating apparatus 100 depicted in FIG. 1 are implemented using programs and data stored on the ROM 302, the RAM 303, the magnetic disk 305, the optical disk 307, etc. of the navigation apparatus 300 depicted in FIG. 3 to execute a given program on the CPU 301 and control each unit in the navigation apparatus 300.

In other words, the navigation apparatus 300 of the present example can execute the functions of the playlist generating apparatus 100 depicted in FIG. 1 according to the playlist generation processing procedure depicted in FIG. 2, by executing a playlist generating program stored on the ROM 302, a recording medium of the navigation apparatus 300.

### (Overview of Playlist Generation Processing)

Next, the playlist generation processing by the navigation apparatus 300 will be described. In the description hereinafter as one example of content, a case where a playlist is to be generated for music will be described. Music includes a portion that is the most upbeat, i.e., the so-called “hook”. The “hook” is also portion that characterizes the music and in this sense, in the present example, “hook” also has the meaning of “characterizing portion”. The navigation apparatus 300 evaluates the user's taste for a played track according to whether the hook was listened to. Based on this evaluation, the navigation apparatus 300 can generate a playlist satisfying user preference by selecting music that is thought to be liked by the user.

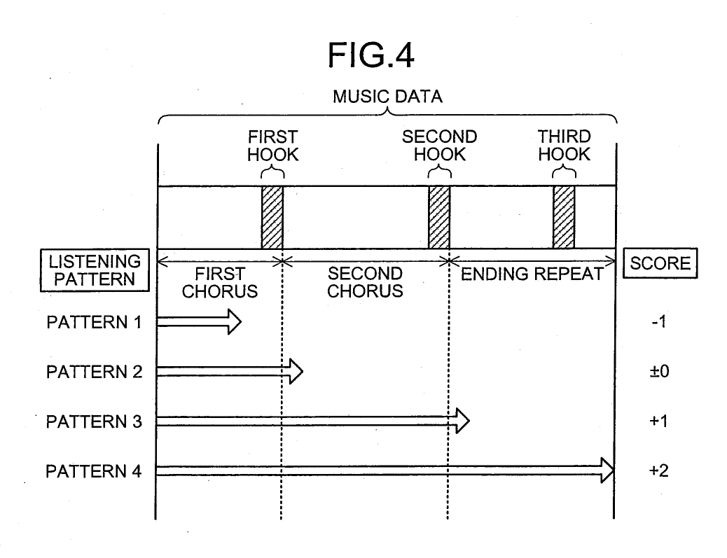

FIG. 4 is a diagram for describing an evaluation method of a track of music. The navigation apparatus 300 by a known technology (e.g., Patent Document 3 above) preliminarily detects the position of a hook in a track to be played. Information indicating the position of the hook may be included in the music data as appended data. In the example depicted in FIG. 4, in the music data, there are 3 hook locations. A first hook is located at the end of a first chorus, a second hook is located at the end of a second chorus, and a third hook is an ending repeat.

As a listening pattern for such a track, the following 4 patterns are conceivable. Pattern 1: after the track has started, listening is terminated before the first hook ends. Pattern 2: after listening up to the first hook, listening is terminated before the second hook ends. Pattern 3: after listening up to the second hook, listening is terminated before the track ends. Pattern 4: From start to end, the entire track is listened to.

The navigation apparatus 300 assigns a score to the track according to the listening pattern of the user. For example, for pattern 1, −1 point; for pattern 2, ±0 points; for pattern 3, +1 point; and for pattern 4, +2 points, such that the larger the proportion listened to is, the higher the score is. This score is stored to a content evaluation database and is used upon generation of a playlist. If the content is video, the navigation apparatus 300 uses a known technology (e.g., Patent Document 4 above) to extract a highlight in the video and gives a score according to whether the highlight has watched.

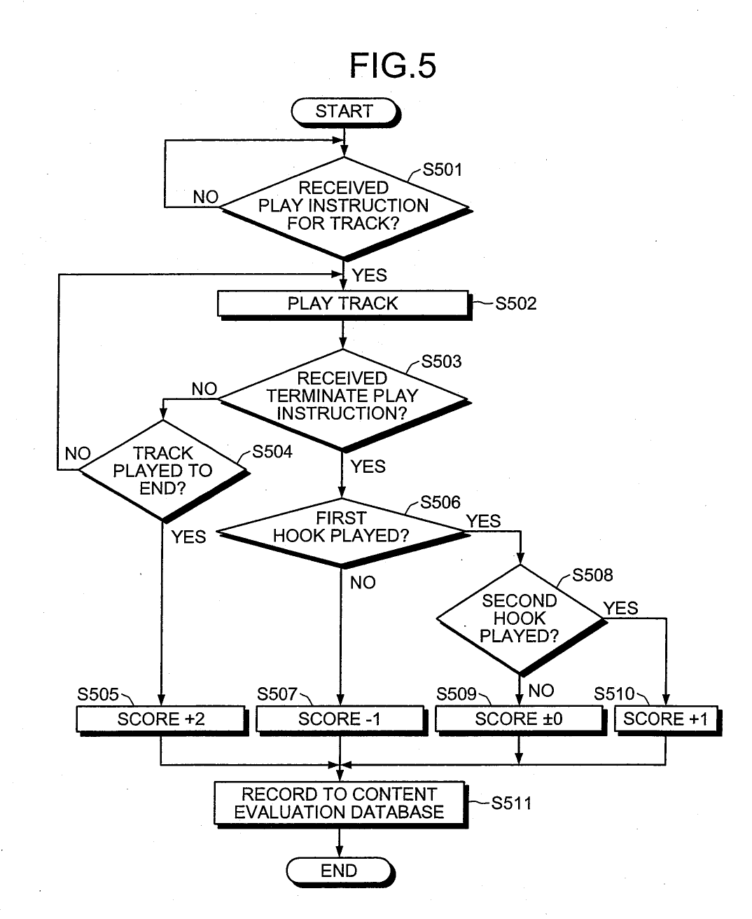

FIG. 5 is a flowchart of a procedure of music evaluation processing by the navigation apparatus. As depicted, in the flowchart depicted in FIG. 5, the navigation apparatus 300 remains in standby until a play instruction for a track is received from the user (step S501: NO). Upon a play instruction (step S501: YES), the navigation apparatus 300 plays the track according to the play instruction (step S502). If there is no terminate play instruction while the track is being played (step S503: NO), the track is played until the end (step S504: NO), and the flow returns to step S502 and the playing of the track continues. Upon playing the track to the end (step S504: YES), the navigation apparatus 300 adds 2 to the score of the played content (step S505), and the flow proceeds to step S511.

On the other hand, at step S503, if a terminate play instruction is received while the track is being played (step S503: YES), the navigation apparatus 300 determines whether the first hook of the track has been played (step S506). If the first hook has not been played (step S506: NO), in other words, if there is a terminate play instruction during the first chorus, the navigation apparatus 300 subtracts 1 from the score of the played content (step S507), and the flow proceeds to step S511.

If the first hook has been played (step S506: YES), the navigation apparatus 300 determines whether the second hook has been played (step S508). If the second hook has not been played (step S508: NO), in other words, if there is a terminate play instruction during the second chorus, the navigation apparatus 300 adds 0 to the score of the played content (step S509), and the flow proceeds to step S511.

If the second hook has been played (step S508: YES), in other words, if there is a terminate play instruction during the ending repeat, the navigation apparatus 300 adds 1 to the score of the played content (step S510). Subsequently, the navigation apparatus 300 records to the content evaluation database, the score given to the content (step S511), ending the processing according to the flowchart.

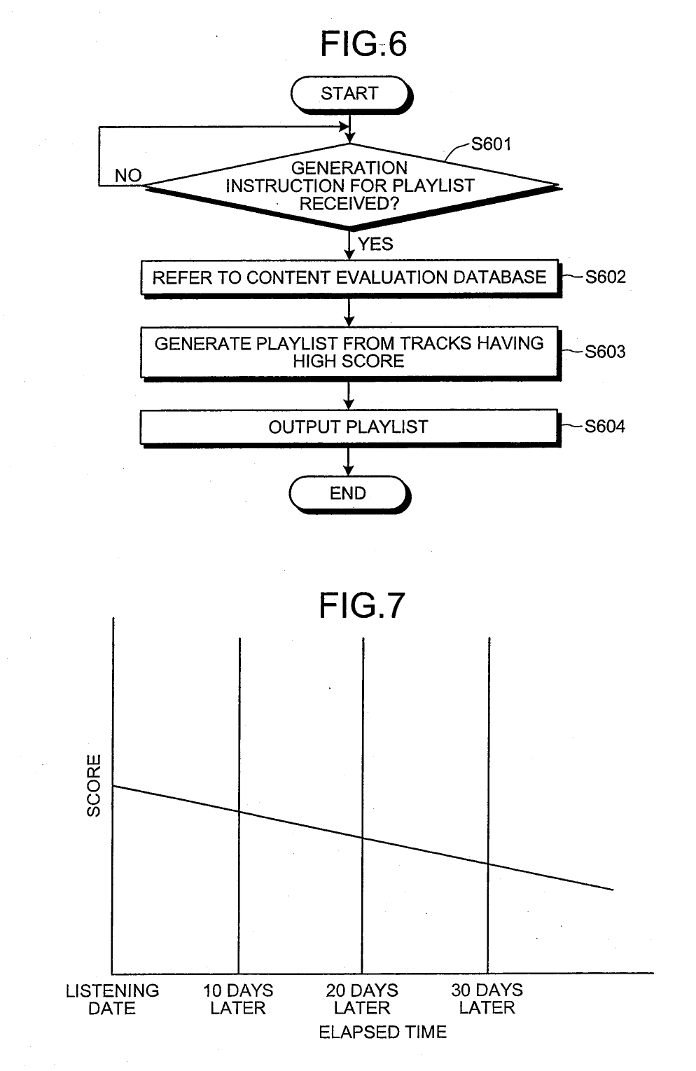

FIG. 6 is a flowchart of a procedure of the playlist generation processing by the navigation apparatus. As depicted in the flowchart in FIG. 6, the navigation apparatus 300 remains in standby until a generation instruction for a playlist is received from the user (step S601: NO). Upon a generation instruction for a playlist (step S601: YES), the navigation apparatus 300 refers to the content evaluation database (step S602), and generates a playlist from tracks having a high score (step S603). Here, the tracks included in the playlist are, for example, tracks having a score equal to or greater than a given value, or tracks in descending order of score. The generated playlist is output to the display 313, etc. (step S604). Through such processing, the navigation apparatus 300 evaluates tracks and generates a playlist.

The dates and times that tracks are listened to are preliminarily stored to content evaluation database and scores may be set to be lower according to the time that has elapsed since the last date and time of listening. Considering that user preference changes over time, a track that in the past was frequently listened to, but recently is not listened to very often, may be a track that does not satisfy current preferences of the user. By lowering the score according to the amount of time that has elapsed since the last date and time of listening, it becomes possible to make it more difficult to include in the playlist, a track the does not satisfy current preferences of the user.

FIG. 7 is a graph depicting an example of the relation between the score given to a track and elapsed time since the date of listening. In the graph depicted in FIG. 7, the vertical axis represents the score of the track; the horizontal axis represents elapsed time from the last date of listening. In FIG. 7, the score decreases at a constant rate relative to the elapsed time from the last date of listening. In addition to this manner of a constant decrease of the score, the score may decrease exponentially or in a stepwise manner.

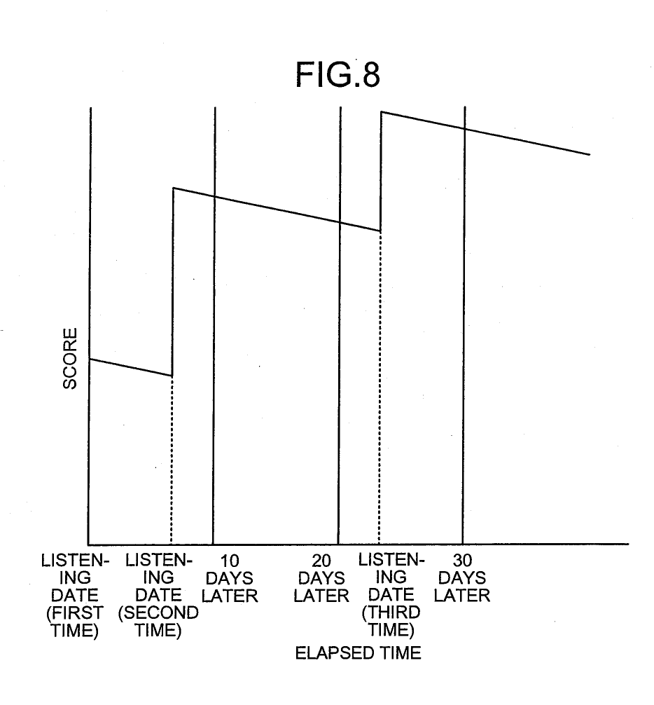

FIG. 8 is a graph of another example of the relation of the score given to a track and elapsed time since the date of listening. In FIG. 8, 7 days after a first listening of a track, a second listening of the track occurs, and 23 days after the first listening of the track, a third listening of the track occurs. As depicted in FIG. 8, although the score decreases accompanying the elapse of time since the previous date of listening, by repeated listening, the score increases, increasing the possibility that the track will be included in the playlist.

Further, by storing to the content evaluation database, the date and time of listening to a track and the score at that time, a playlist reflecting past user-preferences can also be generated. For example, by using tracks having high scores among the tracks listened to by the user in 2005 to generate a playlist, a playlist reflecting user preference in 2005 can be generated. Further, by storing for each track, the date and time of the highest score, a playlist according to period can be generated.

Further, there are devices having, as functions when the tracks are played, a function of repeating tracks by album, track, playlists, etc; a function of randomly playing tracks; and a function of shuffling and playing tracks. The utilization states of these functions may be reflected in the scores of the tracks. For example, if repeated play by track is performed, 2 points are added; if repeated play by album is performed, 1 point is added; if random play or shuffle is performed, 0 points are added. Consequently, it becomes clear whether the user has intentionally played a given track and this can be reflected in the score.

Moreover, by supplementing the contents of the content evaluation database with the place, the weather, companions, etc. at the time that a track was listened to, user preferences can be grasped according to situation. Consequently, a playlist can be generated according to situation, expanding the variation of the playlists.

As described, according to the navigation apparatus 300, based on whether the user has listened to a hook, a score is given to the track, and using this score, a playlist is generated. Consequently, a playlist reflecting, with high accuracy, user preference can be generated. Further, according to the navigation apparatus 300, the score given to a track can be changed according to date and time information indicating when the user listened to/viewed the content, whereby a playlist can be generated that reflects, with high accuracy, user preferences, which change over time.

As forms of listening to/viewing content, content stored in the navigation apparatus 300 may be played, content stored on a content server at the residence of the user may be played, content stored on a content server of a content service provider and obtained by connecting to the content server via a network, may be played. The present invention is applicable any of the forms of content. The content evaluation database may be provided in the navigation apparatus 300 and in which case, a content server storing the data of the content may be provided.

The playlist generating method explained in the present embodiment may be implemented by executing a program that is prepared in advance on a computer, such as a personal computer and a workstation. The program is recorded on a computer-readable recording medium such as a hard disk, a flexible disk, a CD-ROM, an MO, and a DVD, and is executed by being read out from the recording medium by a computer. The program may be distributed through a network such as the Internet.

1-10. (canceled)

11. A playlist generating apparatus that generates a playlist of content items to be played on a content playing apparatus, the playlist generating apparatus comprising:
an acquiring unit that acquires information related to a content item portion listened to/viewed by a user, the content item including a plurality of given portions;
a determining unit that using the acquired information, determines what proportion of the given portions has been listened to/viewed by the user; and
a generating unit that generates the playlist, based on a determination result obtained by the determining unit.

12. The playlist generating apparatus according to claim 11, wherein the generating unit preferentially includes in the playlist, the content items having a high proportion of given portions that have been listened to/viewed.

13. The playlist generating apparatus according to claim 11, wherein
the content item includes a music track, and
the given portion is a hook of the music track.

14. The playlist generating apparatus according to claim 11, wherein
the acquiring unit acquires for the content item, date and time information of listening/viewing by the user, and
the generating unit generates the playlist, based on the date and time information and the determination result.

15. The playlist generating apparatus according to claim 11, wherein
the acquiring unit acquires surrounding environment information for the time when the content item was listened to/viewed, and
the generating unit generates the playlist, based on the surrounding environment information and the determination result.

16. The playlist generating apparatus according to claim 11, wherein the generating unit, based on the determination result, gives the content item a score and based on the score, generates the playlist.

17. The playlist generating apparatus according to claim 16, wherein the generating unit increases the score given to the content items having a portion that has been listened to/viewed and includes the content items in the playlist in descending order of score.

18. The playlist generating apparatus according to claim 16, wherein the generating unit lowers the score given to a content item, according to the time that has elapsed since the last date and time of listening of the content item.

19. A playlist generating apparatus that generates a playlist of content items to be played on a content playing apparatus, the playlist generating apparatus comprising:
a listening/viewing history information acquiring unit that acquires information related to a portion listened to/viewed by a user during a past listening/viewing of a content item and further acquires, as past surrounding environment information, surrounding environment information for the past listening/viewing of the content item;
a determining unit that using the acquired information related to a portion listened to/viewed by the user, determines whether a given portion of the content item has been listened to/viewed by the user;
a current-listening/viewing information acquiring unit that acquires, as current surrounding environment information, the surrounding environment information for the current listening/viewing of the content item by the user; and
a generating unit that generates the playlist, based on the past surrounding environment information, the current surrounding environment information, and a determination result obtained by the determining unit.

20. The playlist generating apparatus according to claim 19, wherein the generating unit preferentially includes in the playlist, the content items listened to/viewed in a surrounding environment similar to that indicated by the current surrounding environment information.

21. The playlist generating apparatus according to claim 19, wherein the generating unit preferentially includes in the playlist, the content items having a given portion that has been listened to/viewed.

22. The playlist generating apparatus according to claim 19, wherein
the content item includes a music track, and
the given portion is a hook of the music track.

23. The playlist generating apparatus according to claim 19, wherein
the listening/viewing history information acquiring unit further acquires for the content item, date and time information of listening/viewing by the user, and
the generating unit generates the playlist, based on the date and time information and the determination result.

24. The playlist generating apparatus according to claim 19, wherein the generating unit based on the determination result, gives the content items a score and based on the score, generates the playlist.

25. The playlist generating apparatus according to claim 24, wherein the generating unit increases the score given to the content items having a portion that has been listened to/viewed and includes the content items in the playlist in descending order of score.

26. The playlist generating apparatus according to claim 24, wherein the generating unit lowers the score given to a content item, according to the time that has elapsed since the last date and time of listening of the content item.

27. A playlist generating method of generating a playlist of content items to be played on a content playing apparatus, the playlist generating method comprising:
acquiring information related to a content item portion listened to/viewed by a user, the content item including a plurality of given portions;
determining, using the acquired information, what proportion of the given portions has been listened to/viewed by the user; and
generating the playlist, based on a determination result obtained at the determining.

28. A playlist generating method of generating a playlist of content items to be played on a content playing apparatus, the playlist generating method comprising:
acquiring information related to a portion listened to/viewed by a user during a past listening/viewing of a content item and further acquiring, as past surrounding environment information, surrounding environment information for the past listening/viewing of the content item;
determining, using the acquired information related to a portion listened to/viewed by the user, whether a given portion of the content item has been listened to/viewed by the user;
acquiring, as current surrounding environment information, the surrounding environment information for the current listening/viewing of the content item by the user; and
generating the playlist, based on the past surrounding environment information, the current surrounding environment information, and a determination result obtained at the determining.

29. A computer-readable recording medium storing therein a playlist generating program causing a computer to execute the playlist generating method according to claim 27.

30. A computer-readable recording medium storing therein, a playlist generating program causing a computer to execute the playlist generating method according to claim 28.
